(19) United States
(12) Patent Application Publication
(10) Pub. No.: US 2019/0346000 A1
(43) Pub. Date: Nov. 14, 2019

(54) Grooved Disc Brake

(71) Applicant: Bremskerl North America, Inc., Bartlett, IL (US)

(72) Inventors: John P. Konrad, Arlington Heights, IL (US); Glenn Guelde, Malta, IL (US)

(21) Appl. No.: 16/107,813

(22) Filed: Aug. 21, 2018

Related U.S. Application Data
(60) Provisional application No. 62/669,218, filed on May 9, 2018.

(51) Int. Cl. F16D 69/00

(52) U.S. Cl. CPC F16D 69/00; F16D 2069/004

(57) ABSTRACT

Example brake pads and methods of manufacturing brake pads are disclosed. An example brake pad for use with a rotor of a disc brake assembly includes a curved substrate. The brake pad also includes a plurality of grooves in the curved substrate, the plurality of grooves defining a plurality of contact surfaces, wherein the plurality of grooves extend radially with respect to a rotational axis of the rotor.

### CROSS-REFERENCE TO RELATED APPLICATION

This application claims priority to U.S. Provisional Patent Application 62/669,218, filed May 9, 2018, the entire contents of which are herein incorporated by reference.

### TECHNICAL FIELD

The present disclosure generally relates to the field of vehicle braking systems and devices and, more particularly, brake pads having grooves thereon that enable uniform and reduced wear of pad and rotor.

### BACKGROUND

Many vehicles make use of disc brake systems to provide stopping power. These disc brake systems, among other things, include the use of a brake pad that is pressed against a rotor in order to increase friction and stop the movement of a vehicle. This type of braking system can be used in commercial vehicles such as Class 4-8 trucks and busses, as well as trains.

The brake pad is held by a caliper that acts to press the brake pad against the rotor. The brake pad remains in a fixed position with respect to the rotor rotation, and only moves toward and away from the rotor in order to increase or decrease friction between the two components. The brake pad is a component of the brake systems held by a caliper assembly. The brake pad remains in a fixed rotational position with respect to the rotor rotation. The caliper applies a force to the brake pad(s) which creates friction between the rotor and brake pad.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example brake pad according to embodiments of the present disclosure.

FIG. 2 illustrates a perspective view of the brake pad of FIG. 1 or FIG. 3 according to embodiments of the present disclosure.

FIG. 3 illustrates another example brake pad according to embodiments of the present disclosure.

FIG. 4 illustrates an example view of the two sections of the brake pad of FIG. 3, according to embodiments of the present disclosure.

FIG. 5 illustrates a flow chart of an example method according to embodiments of the present disclosure.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown describing systems, apparatuses, and methods for manufacturing a grooved brake pad that enables a disc brake system to have improved, more reliable, and more robust performance. In one example, a brake pad for use with a rotor of a disc brake assembly includes a curved substrate. The brake pad also includes a plurality of grooves in the curved substrate, the plurality of grooves defining a plurality of contact surfaces, wherein the plurality of grooves extend radially with respect to a rotational axis of the rotor.

In a second example, a method of manufacturing a brake pad for use with a rotor of a disc brake assembly includes forming a curved substrate. The method also includes forming a plurality of grooves in the curved substrate, the plurality of grooves defining a plurality of contact surfaces, wherein the plurality of grooves extend radially with respect to a rotational axis of the rotor.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As noted above, many vehicles make use of disc brake systems which include a rotating rotor and a brake pad. These systems are required to manage the large amount of heat that is generated while stopping the vehicles. Over the lifetime of a given brake pad, outside debris, brake pad debris from wear, and heat generated during use of the brake pad create situations in which the brake pad and/or one or more other components of the braking system must be replaced to ensure that certain safety measures are met. This can often occur before the brake pad (or other component) has reached its full potential life cycle, thereby increasing costs and the necessity of maintenance.

Regarding disc brake pads in particular, there may be two particularly important factors that decrease the life of the pad, and thereby increase costs over time. The first factor is called “tapered wear” of the brake pad. Tapered wear may occur when heat created during the brake application is not uniform across a surface area of the disc brake pad. The localized increased temperature can increase the wear rate of the friction material of the brake pad near the location of the elevated temperature. This in turn can cause non-uniform performance of the brake pad, due to the change in contact surface area between the rotor and the pad over time.

A second factor that can lead to a decrease in the lifespan of a brake pad may be called “cupping” or “dishing” of the disc brake rotor. Cupping of the disc brake rotor can be caused by wear debris of the friction material and/or disc brake rotor being trapped between the disc brake rotor and disc brake pad. As the rotor spins with respect to the brake pad, a leading edge of the brake pad may wear and result in debris between the rotor and the pad near the leading edge. As the rotor continues rotating toward a trailing edge of the brake pad, the debris may ride along with the rotor toward the trailing edge, thereby increasing wear along the line taken by the debris. Where there is no outlet for the debris to escape, it may continue along between the rotor and the brake pad the entire length of the pad, until it is finally free after passing by the trailing edge. This non-uniform presence of debris can cause cupping, which in turn reduces the uniformity of the heat generation, friction material wear, and ultimately the lifespan of the brake pad and rotor.

In addition to tapered wear and cupping, the general presence of both outside debris and wear debris from the brake pad trapped between the rotor and the brake pad can affect the frictional output of the brake system. Debris can cause reduced frictional output of the system, by acting as a friction modifier creating a boundary layer, thereby preventing the brake pad from contacting the rotor as designed. This can lead to a reduced lifespan, reduced performance, and various other cost and safety concerns.

With these issues and concerns in mind, example embodiments of the present disclosure may provide uniformity of friction, wear, debris removal, and performance of the brake pad over time. The “balanced” groove design results in a brake pad that provides improved performance.

It is understood that frictional output of the friction material used in disc brake pads is directly related to the temperature of the friction material. High temperatures can cause an effect called “brake fade.” When there are localized areas of high temperatures, the friction can decrease (known as friction fade) in these areas forcing other areas of the disc brake pad to be responsible for more of the kinetic energy than they were originally designed to handle.

Example grooved brake pads of this disclosure may provide the ability to remove debris from between the brake pad and rotor, thereby alleviating some of the issues caused by this debris. Further, example grooved brake pads of this disclosure may increase the uniformity of friction during use of the pad, thereby reducing the issues caused by non-uniform heat generation.

These benefits may be caused by the use of a plurality of grooves formed into a brake pad substrate, on the face of the substrate configured for contact with the rotor. These grooves may be positioned such that they extend radially from a center point of the rotation of the rotor. As the rotor spins and contacts the brake pad, any debris generated near the leading edge may be caught in the forward-most groove, where it can fall into the groove and out of the space between the rotor and the pad. Debris caught in other areas of the pad will likewise fall into the other grooves where it can fall out of the space between the rotor and pad. The contact surface of the brake pad may also be sized such that a surface area of each portion of the substrate is equal. This may ensure increase uniformity of friction across the surface of the pad, resulting in less wear, improved performance, and an increased life span of the pad and/or rotor.

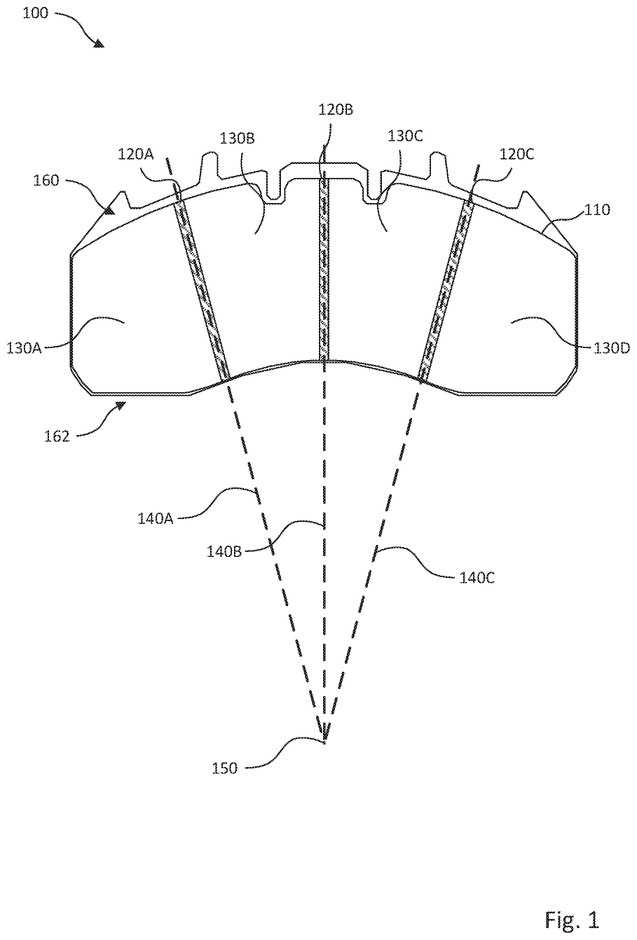

FIG. 1 illustrates an example grooved brake pad 100 according to embodiments of the present disclosure. Grooved brake pad 100 may include a substrate 110 and a plurality of grooves 120A-C, which define a plurality of contact surfaces 130A-D.

Substrate 110 may be any suitable material, including non-metallic, semi-metallic, fully metallic, sintered and ceramic materials. Other materials may be used as well. Substrate 110 may be configured such that it has a curved shape, as shown in FIG. 1. In some examples, substrate 110 may include one or more cutouts, protrusions, and/or other features which may be used for coupling the brake pad 110 to a backing plate, dovetail key, caliper or other components of a brake system.

Substrate 110 may be any suitable size and thickness. Substrate 110 may include a flat front face configured to contact a rotor, in order to proving a braking force to slow down and/or stop a vehicle.

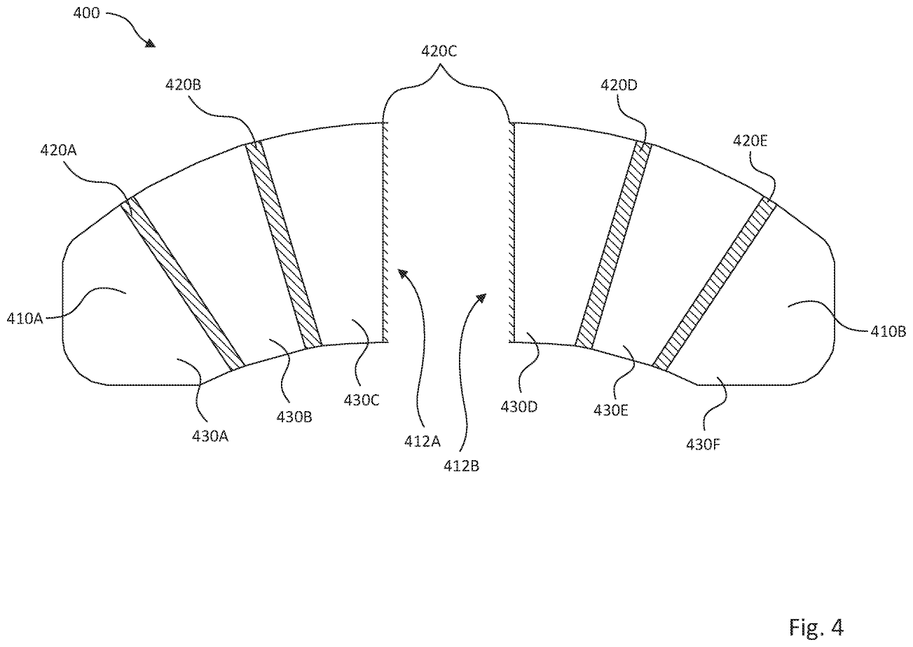

FIG. 1 illustrates substrate 110 having a top edge 160, a bottom edge 162, and a front face having a plurality of grooves formed defining a plurality of contact surfaces 130A-D. Substrate 110 may be a single unitary substrate as shown in FIG. 1, or substrate 110 may be composed of two or more separate sections, as shown and described in more detail with respect to FIG. 4.

In some examples, a plurality of grooves may be cut into the front face of the substrate 110. These grooves are shown in FIG. 1 as grooves 120A-C.

In some examples, one or more of grooves 120A-C may be straight, while in other examples one or more of grooves 120A-C may have a curve with respect to substrate 110. Further, grooves 120A-C may be relatively narrow, such as one cm or smaller, up to two cm or more.

In some examples, one or more of grooves 120A-C may extend through both the top edge 160 and bottom edge 162 of substrate 110 as shown. In other examples, one or more of the grooves 120A-C may not extend fully through either or both of the top edge 160 and bottom edge 162.

In some examples, the plurality of grooves may be non-overlapping with each other, such that each groove does not contact any other groove.

Grooves 120A-C may be formed in the substrate 110 such that they extend radially with respect to a rotational axis of a rotor of the disc brake assembly. This is illustrated in FIG. 1 via dashed lines 140A-C, which correspond to the grooves 120A-C. Each groove 120A-C is formed in the substrate 110 such that it follows a radially extending axis 140A-C from point 150. Point 150 is a center point of the rotor about which the rotor rotates.

In some examples, a pitch or spacing between the grooves may be such that all grooves are evenly spaced along a length of the pad. And depending on the size of the pad, this may correspond to an angle between the radially extending axes 140A-C of between 5-20 degrees. It should be noted that other angles are possible as well.

The plurality of grooves 120A-C define a plurality of contact surfaces 130A-D on the front face of the substrate 110. In FIG. 1, there are three grooves, and there are four corresponding contact surfaces. In some examples, there may be N grooves and N+1 contact surfaces. However in other examples, there may be a different relationship between the number of grooves and the number of contact surfaces.

In some examples, the contact surfaces 130A-D may be same material as substrate 110. In other examples, the contact surfaces may be coated with a friction material or some other suitable material.

Contact surfaces 130A-D may be flat, concave, convex, or any other suitable shape, and may be configured for contact with a rotor.

Each contact surface 130A-D may have equal surface area to the other contact surfaces. As such, even where one or more contact surfaces has a different shape, they may still have equal surface area. As shown in FIG. 1, contact surface 130A has a different shape than contact surface 130B. However even though they have different shapes, grooves 120A and 120B may be positioned on substrate 110 such that surface area of contact surface area 130A is equal to the surface area of contact surface 130B. This may extend to the position of all grooves and the surface area of all contact surfaces 130 on the substrate 110.

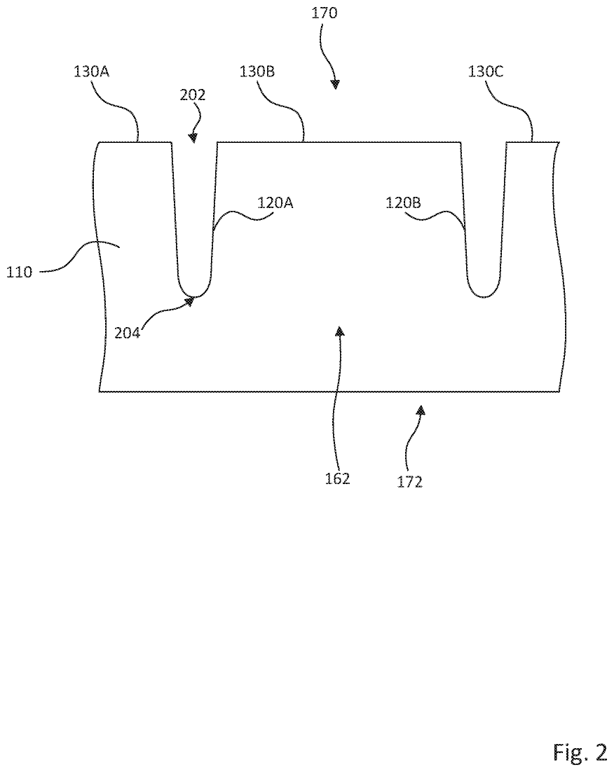

FIG. 2 illustrates a perspective view of the grooved brake pad 100 of FIG. 1. FIG. 2 illustrates the substrate 110 viewed from the bottom edge 162.

As can be seen in FIG. 2, substrate 110 may have a front face 170 and a back face 172, which in some examples may be affixed to a backing plate.

Groove 120A is illustrated as having a top side 202 and a bottom side 204 opposite the top side 202. The top side 202 may be flush with the front face 170 of substrate 110, as well as the contact surfaces 130A-D.

In some examples, all grooves may be similar or identical, and as such may all have respective top sides and bottom sides. Some example groove top side widths may include 1 cm or smaller, up to 2 cm or more. Further, some example bottom side widths may include 1 cm or smaller, up to 2 cm or more. Each groove may also have a particular depth, which may range from 1 cm or smaller, up to 2 cm or more.

With respect to each groove, in some examples the top side 202 may be wider than the bottom side 204. Alternatively, the top side 202 may be narrower than bottom side 204. These may be referred to as “tapered grooves.” Each tapered groove may have a taper angle, which can range from 5 degrees or less, up to 20 degrees or more. Further, in some examples, a top side 202 and/or a bottom side 204 of a given groove may be wider proximate a top edge 160 of substrate 110, and narrower proximate a bottom edge 162. Alternatively, a top side 202 and/or a bottom side 204 of a given groove may be wider proximate a bottom edge 162 and narrower proximate a top edge 160 of substrate 110. Further examples may include grooves having varying top side and bottom side widths over the length of the groove.

In some examples, the bottom side of a groove may be curved, as shown in FIG. 2. Alternatively, the bottom side of a given groove may be flat, convex, concave, or any other shape. Further, the shape of the bottom side may change over the length of the groove.

It should be noted that the examples illustrated in the Figures are one possible configuration and structure of the grooves. Other examples may include one or more grooves having one or more features that differ from the other groove(s), such that one groove is tapered while another groove is not. Other variations are possible as well.

As shown in FIG. 1, some embodiments may include three grooves. These example brake pads may be particularly suited for use with a commercial vehicle disc brake assembly, such as for a bus or truck. These brake pads may include additional protrusions and/or cutouts such that the pad can fit into a particular commercial vehicle disc brake assembly.

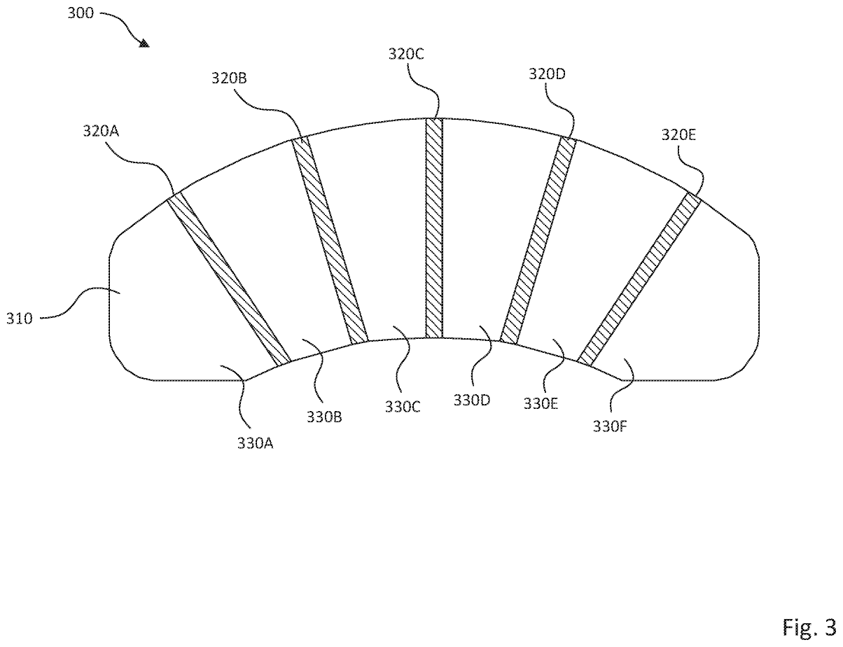

In other embodiments, the grooved brake pad may include a different number of grooves, from as low as one to as high as five or more. FIG. 3 illustrates an example grooved brake pad 300 having five grooves 320A-E.

Pad 300 may have a substrate 310 which may be similar or identical to substrate 110 described above. Pad 300 may also include a plurality of grooves 320A-E which define contact surfaces 330A-F. Grooved brake pad 300 may be particularly suited for use with a rail disc brake assembly on a train.

It should be understood that any number of grooves may be used, and that the embodiments described herein may be used in connection with any disc brake assembly.

As noted above, example brake pads disclosed herein may include a single substrate that is of unitary construction, and is a single component with grooves cut or formed into it. FIG. 4 illustrates another example brake pad 400, wherein the substrate is comprised of a first section 410A and a second section 410B.

The first section 410A may have a first edge 412A configured to couple to a second edge 412B of the second section 410B, thereby forming the completed full brake pad 400.

Pad 400 may include grooves 420A-E, which define a plurality of contact surfaces 430A-F. Groove 420C may have a first wall and a second wall defined by the first edge 412A and second edge 412B of the first and second sections.

In some examples, the different sections of the pad may meet and define a groove as shown in FIG. 4 (i.e., symmetrically in the center of the pad 400). However it should be noted that in other examples the edges between various sections may not define a groove, but may instead separate one or more contact surfaces.

Further, the two sections shown in FIG. 4 are symmetrical. It should also be noted that they may be split unevenly or asymmetrically in any suitable manner, such that a first section is larger than another. Further, the placement of grooves on the sections may be symmetrical or asymmetrical, such that a first section may have a different number of grooves than another.

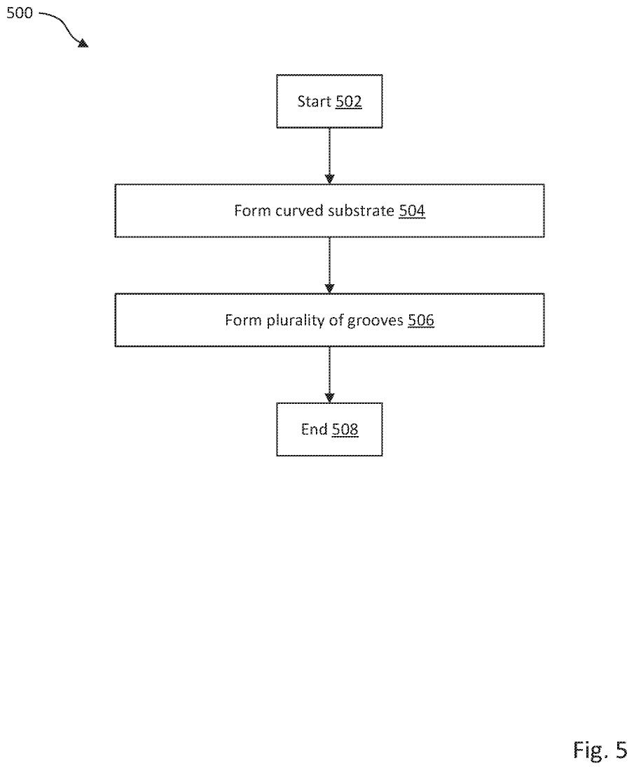

FIG. 5 illustrates an example method 500 according to embodiments of the present disclosure. Method 500 may enable the manufacturing of a grooved brake pad disclosed herein. While the example method is described with reference to the flowchart illustrated in FIG. 5, many other methods for carrying out the functions described herein may alternatively be used. For example, the order of execution of the blocks may be rearranged or performed in series or parallel with each other, blocks may be changed, eliminated, and/or combined to perform method 500. Further, because method 500 is disclosed in connection with the components of FIGS. 1-4, some functions of those components will not be described in detail below.

Method 500 may begin at block 502. At block 504, method 500 may include forming a curved substrate. The curved substrate may be similar or identical to substrates 110, 310, and 410 described in this disclosure.

At block 506, method 500 may include forming a plurality of grooves in the substrate. The plurality of grooves may have any of the features described herein, such as being straight, tapered, extending through the top and bottom edges of the substrate, and more. Further, example methods may include forming any number of grooves in the substrate, such as three grooves (e.g., FIG. 1), five grooves (e.g., FIGS. 3 and 4), as well as more or fewer grooves. The grooves may be positioned such that the surface area of the contact surfaces defined by the grooves are equal. Method 500 may then end at block 508.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1. A brake pad for use with a rotor of a disc brake assembly comprising:
a curved substrate; and
a plurality of grooves in the curved substrate, the plurality of grooves defining a plurality of contact surfaces,
wherein the plurality of grooves extend radially with respect to a rotational axis of the rotor.

2. The brake pad of claim 1, wherein each of the plurality of grooves is straight.

3. The brake pad of claim 1, wherein the plurality of grooves are non-overlapping.

4. The brake pad of claim 1, wherein the substrate comprises a top edge and a bottom edge, and wherein the plurality of grooves extend through both the top edge and the bottom edge.

5. The brake pad of claim 1, wherein each of the plurality of grooves comprises:
a top side flush with the plurality of contact surfaces; and
a bottom side opposite the top side, wherein the bottom side is curved.

6. The brake pad of claim 1, wherein each of the plurality of grooves comprises:
a top side flush with the plurality of contact surfaces; and
a bottom side opposite the top side, wherein the top side is wider than the bottom side.

7. The brake pad of claim 1, wherein the plurality of grooves comprises five grooves, and wherein the brake pad is configured for use with a rail disc brake assembly.

8. The brake pad of claim 1, wherein the plurality of grooves comprises three grooves, and wherein the brake pad is configured for use with a commercial vehicle disc brake assembly.

9. The brake pad of claim 1, wherein the plurality of contact surfaces have equal surface area configured for contact with the rotor.

10. The brake pad of claim 1, wherein the curved substrate comprises a first section and a second section, and wherein a first edge of the first section and a second edge of the second section define walls of one of the plurality of grooves.

11. A method of manufacturing a brake pad for use with a rotor of a disc brake assembly comprising:
forming a curved substrate; and
forming a plurality of grooves in the curved substrate, the plurality of grooves defining a plurality of contact surfaces,
wherein the plurality of grooves extend radially with respect to a rotational axis of the rotor.

12. The method of claim 11, wherein each of the plurality of grooves is straight.

13. The method of claim 11, wherein the plurality of grooves are non-overlapping.

14. The method of claim 11, wherein the substrate comprises a top edge and a bottom edge, and wherein the plurality of grooves extend through both the top edge and the bottom edge.

15. The method of claim 11, wherein each of the plurality of grooves comprises:
a top side flush with the plurality of contact surfaces; and
a bottom side opposite the top side, wherein the bottom side is curved.

16. The method of claim 11, wherein each of the plurality of grooves comprises:
a top side flush with the plurality of contact surfaces; and
a bottom side opposite the top side, wherein the top side is wider than the bottom side.

17. The method of claim 11, wherein the plurality of grooves comprises five grooves, and wherein the brake pad is configured for use with a rail disc brake assembly.

18. The method of claim 11, wherein the plurality of grooves comprises three grooves, and wherein the brake pad is configured for use with a commercial vehicle disc brake assembly.

19. The method of claim 11, wherein the plurality of contact surfaces have equal surface area configured for contact with the rotor.

20. The method of claim 11, wherein the curved substrate comprises a first section and a second section, and wherein a first edge of the first section and a second edge of the second section define walls of one of the plurality of grooves.
